(19) United States
(12) Patent Application Publication
(10) Pub. No.: US 2011/0138282 A1
(43) Pub. Date: Jun. 9, 2011

(54) SYSTEM AND METHOD FOR SYNCHRONIZING STATIC IMAGES WITH DYNAMIC MULTIMEDIA CONTENTS

(76) Inventor: Anthony P. Lai, Pleasanton, CA (US)

(21) Appl. No.: 12/962,564

(22) Filed: Dec. 7, 2010

Related U.S. Application Data
(60) Provisional application No. 61/267,432, filed on Dec. 7, 2009.

(51) Int. Cl. G06F 3/048

(52) U.S. Cl. 715/716

(57) ABSTRACT

A system and method for synchronizing static images with dynamic multimedia contents to produce synchronized presentations uses a synchronization user interface with a dynamic multimedia presentation area and a static image thumbnail area that allows a user to synchronize a static image with a dynamic multimedia content with a single user input on a thumbnail of a static image displayed in the static image thumbnail area as the dynamic multimedia content is played in the dynamic multimedia presentation area.

### CROSS REFERENCE TO RELATED APPLICATION

This application is entitled to the benefit of U.S. Provisional Patent Application Ser. No. 61/267,432, filed on Dec. 7, 2009, which is incorporated herein by reference.

### BACKGROUND OF THE INVENTION

There are various systems and methods for synchronizing videos with slides to produce presentations with synchronized videos and slides, which are sometimes referred to herein as “synchronized presentations.” These types of presentations can be used as online or offline teaching tools to passively teach various subjects to interested viewers. Such presentations may mimic typical live presentations, which are presented by one or more speakers using one or more slide presentations. The slide presentations may supplement the oral presentations of the speakers and/or provide highlights of the oral presentations.

Current systems and methods to produce synchronized presentations are typically not intuitive and require special knowledge to execute the steps required to produce the synchronized presentations. Furthermore, these steps may involve complex manipulations with respect to the video files and/or the slide files using user interfaces, which may be difficult to navigate to perform specific steps to produce the synchronized presentations.

Therefore, there is a need for a system and method for synchronizing static images, such as slides, with dynamic multimedia contents, such as videos, to produce presentations with synchronized dynamic multimedia contents and static images.

### SUMMARY OF THE INVENTION

A system and method for synchronizing static images with dynamic multimedia contents to produce synchronized presentations uses a synchronization user interface with a dynamic multimedia presentation area and a static image thumbnail area that allows a user to synchronize a static image with a dynamic multimedia content with a single user input on a thumbnail of a static image displayed in the static image thumbnail area as the dynamic multimedia content is played in the dynamic multimedia presentation area.

A method for synchronizing static images with dynamic multimedia contents to produce synchronized presentations in accordance with an embodiment of the invention comprises displaying thumbnails of selectable static images in a static image thumbnail area of a synchronization user interface, playing a dynamic multimedia content in a dynamic multimedia presentation area of the synchronization user interface, and in response to a user selection of a thumbnail of a static image from the thumbnails of the selectable static images using a single user input as the dynamic multimedia content is played, associating a static image with the dynamic multimedia content to synchronize the static image with the dynamic multimedia content to produce a synchronized presentation so that the static image is displayed as the dynamic multimedia content is played when the synchronized presentation is played.

A method for synchronizing static images with dynamic multimedia contents to produce synchronized presentations in accordance with another embodiment of the invention comprises providing a webpage with a synchronization user interface to a requesting computing device, the synchronization user interface including a static image thumbnail area to display thumbnails of selectable static images and a dynamic multimedia presentation area to play a dynamic multimedia content, transmitting data associated with the dynamic multimedia content and the selectable static images to the requesting computing device so that the dynamic multimedia content is played in the dynamic multimedia presentation area of the synchronization user interface and the thumbnails of the selectable static images are displayed in the static image thumbnail area of the synchronization user interface, and in response to a user selection of a thumbnail of a static image from the thumbnails of the selectable static images using a single user input as the dynamic multimedia content is being played, recording information related to the selecting of the thumbnail of the static image to synchronize the static image with the dynamic multimedia content to produce a synchronized presentation so that the static image is displayed as the dynamic multimedia content is played when the synchronized presentation is played.

A system for synchronizing dynamic multimedia contents with static images to produce synchronized presentations in accordance with an embodiment of the invention comprises a synchronization record database, a webpage provider and a synchronization application module. The synchronization record database resides in one or more servers. The synchronization record database is configured to store data related to the synchronized presentations. The webpage provider is executed in the one or more servers. The webpage provider is configured to provide a webpage with a synchronization user interface to a requesting computing device. The synchronization user interface includes a static image thumbnail area to display thumbnails of selectable static images and a dynamic multimedia presentation area to play a dynamic multimedia content. The synchronization application module is executed in the one or more servers. The synchronization application module is configured to record information related to a selection of a thumbnail of a static image from the thumbnails of the selectable static images in the synchronization record database to synchronize the static image with the dynamic multimedia content to produce a synchronized presentation so that the static image is displayed as the dynamic multimedia content is played when the synchronized presentation is played.

Other aspects and advantages of the present invention will become apparent from the following detailed description, taken in conjunction with the accompanying drawings, illustrated by way of example of the principles of the invention.

### BRIEF DESCRIPTION OF THE DRAWINGS

FIG. 1 is a block diagram of a network architecture that includes a multimedia synchronization system in accordance with an embodiment of the invention.

FIG. 2 is a block diagram of components of the multimedia synchronization system of FIG. 1 in accordance with an embodiment of the invention.

FIG. 3 is a diagram of a synchronization user interface to create a synchronized presentation in accordance with an embodiment of the invention.

FIG. 4 is a diagram of a playback user interface to play a synchronized presentation in accordance with an embodiment of the invention.

FIG. 5 is a process flow diagram of a method for synchronizing static images with dynamic multimedia contents to produce synchronized presentations in accordance with an embodiment of the invention.

FIG. 6 is a process flow diagram of a method for synchronizing static images with dynamic multimedia contents to produce synchronized presentations in accordance with another embodiment of the invention.

### DETAILED DESCRIPTION

It will be readily understood that the components of the embodiments as generally described herein and illustrated in the appended figures could be arranged and designed in a wide variety of different configurations. Thus, the following detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment. Rather, language referring to the features and advantages is understood to mean that a specific feature, advantage, or characteristic described in connection with an embodiment is included in at least one embodiment. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment. Thus, the phrases “in one embodiment,” “in an embodiment,” and similar language throughout this specification may, but do not necessarily, all refer to the same embodiment.

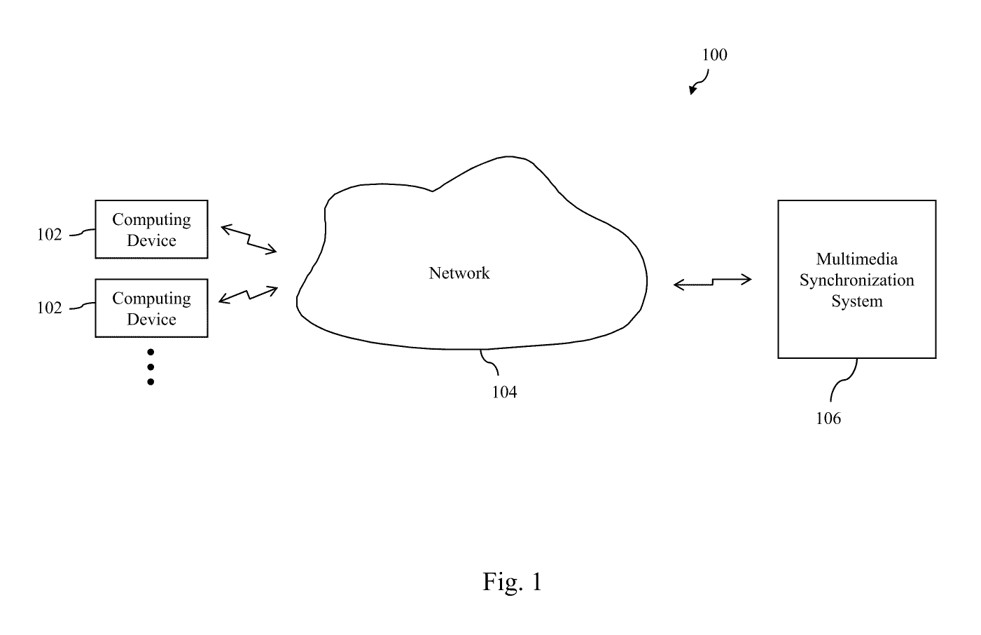

With reference to FIG. 1, a network architecture 100 for producing presentations with synchronized dynamic multimedia contents and static images is described. As used herein, dynamic multimedia contents refer to any multimedia contents, which may include visual and/or audio contents, having fixed play durations during which visual and/or audio contents change over time. As an example, the dynamic multimedia contents may be video files with or without audio having particular play durations. As another example, the dynamic multimedia contents may be audio files having particular play durations. As also used herein, static images refer to any still images. As an example, the static images may be photographic digital image files. As another example, the static images may be computer graphic image files, such as electronic slide files for electronic presentations. The presentations with synchronized dynamic multimedia contents and static images are sometimes referred to herein as “synchronized presentations.”

A synchronized presentation typically includes one dynamic multimedia content, e.g., one video file, with multiple static images, e.g., multiple slide files, that are synchronized to the dynamic multimedia content. However, a synchronized presentation may include any number of dynamic multimedia contents and any number of static images that are synchronized to the dynamic multimedia contents. When a synchronized presentation is played, the dynamic multimedia content is played for its entire play duration and the static images are selectively displayed at selected times during the play duration of the dynamic multimedia content. The creating of the synchronized presentations and playing of the synchronized presentations will be described in detail below.

As shown in FIG. 1, the network architecture 100 includes a number of computing devices 102, a network 104 and a multimedia synchronization system 106. The computing devices can be any type of network-enabled devices, i.e., devices that can connect to the network. As an example, the computing devices may be desktop computers, notebook computers and/or Internet-enabled mobile devices. In some embodiments, the computing devices may utilize web browsers or web browsing applications to access contents via the network. The network can be any computer network. However, in an embodiment, the network includes the Internet and any other smaller networks that connect to the Internet. The network allows the computing devices to communicate with the multimedia synchronization system.

The multimedia synchronization system 106 operates to allow users of the computing devices 102 to access websites provided by the multimedia synchronization system to create new synchronized presentations, save the synchronized presentations and to view the synchronized presentations, which includes synchronized presentations made by other users. As described in more detail below, the multimedia synchronization system provides intuitive, user-friendly interface for users to easily synchronize static images to dynamic multimedia contents to create synchronized presentations. The synchronized presentations can be used as electronic lessons to passively teach various subjects to interested viewers. These synchronized presentations may be viewed online by, for example, accessing one or more websites provided by the multimedia synchronization system or viewed offline by, for example, first downloading the synchronized presentations from one or more websites provided by the multimedia synchronization system and then playing the synchronized presentations on suitable computing devices.

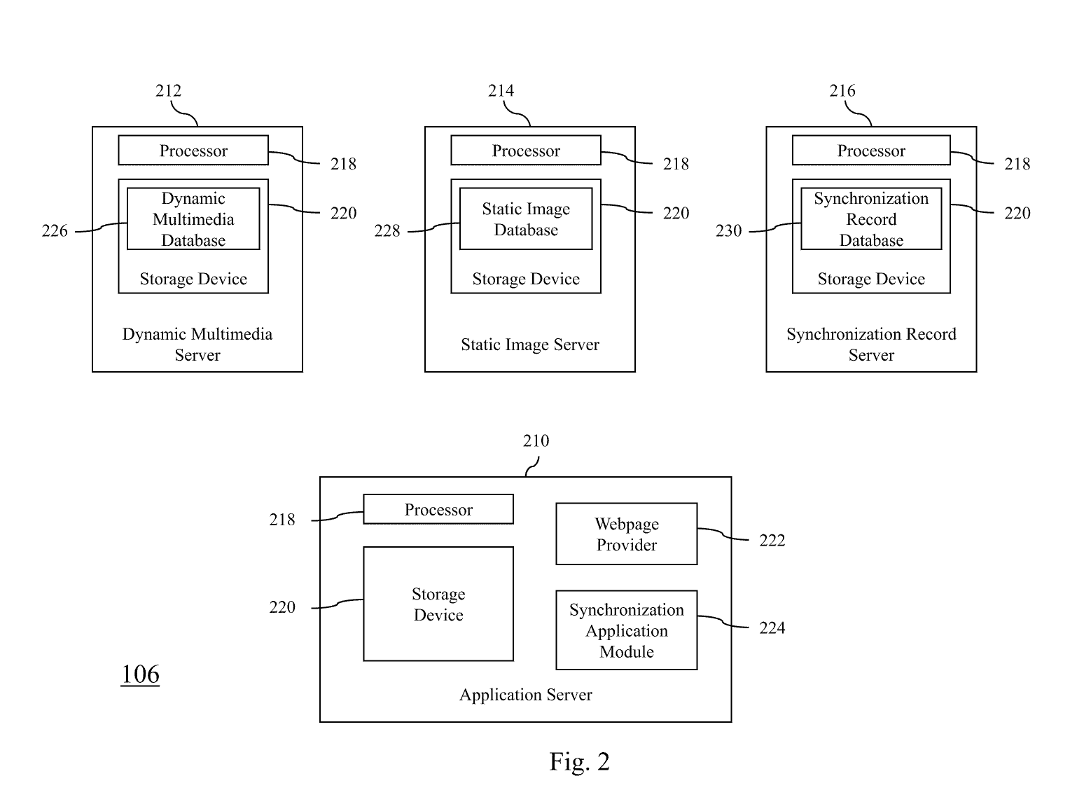

Turning now to FIG. 2, components of the multimedia synchronization system 106 in accordance with an embodiment of the invention are illustrated. As shown in FIG. 2, the multimedia synchronization system includes an application server 210, a dynamic multimedia server 212, a static image server 214 and a synchronization record server 216. Each of the servers includes a processor 218 and a storage device 220. Although only a single processor and a single storage device are illustrated in FIG. 2 for each server, each of these servers may include multiple processors and/or multiple storage devices. In addition, each of these servers includes components commonly found in servers, such as a communication interface for connecting to a network, e.g., the network 104 shown in FIG. 1, as well as other components.

As shown in FIG. 2, the application server 210 includes a webpage provider 222 and a synchronization application module 224. The webpage provider is configured to provide webpages for creating and viewing synchronized presentations when requested from users using the computing devices 102. The webpages provided by the webpage provider are described in detail below. The synchronization application module is configured to facilitate the creating and viewing of synchronized presentations. As described in more detail below, the synchronization application module processes dynamic multimedia contents and static images, as well as any other data, for creating and viewing synchronized presentations. In an embodiment, the webpage provider and the synchronization application module are implemented as computer programs executed by the processor 218 of the application server 210. However, in other embodiments, the webpage provider and the synchronization application module may be implemented in any combination of hardware, firmware and software. Thus, the webpage provider and the synchronization application module may comprise specialized circuits and/or computer programs. Furthermore, in some embodiments, the webpage provider and the synchronization application module may reside in more than one server, for example, in a network of servers. In other embodiments, the webpage provider and the synchronization application module may reside in separate servers.

As also shown in FIG. 2, each of the dynamic multimedia server 212, the static image server 214 and the synchronization record server 216 includes a specialized database. The dynamic multimedia server includes a dynamic multimedia database 226, which contains dynamic multimedia contents uploaded onto the multimedia synchronization system 106 by users. In an embodiment, the synchronization application module 224 may convert uploaded dynamic multimedia contents into particular file formats, such as flv, mp3 or mp4 files, and store these files in the dynamic multimedia database. The uploaded dynamic multimedia contents in the dynamic multimedia database may include dynamic multimedia contents that are synchronized with static images, as well as dynamic multimedia contents that are currently not synchronized with static images. As illustrated in FIG. 2, the dynamic multimedia database may be stored in the storage device 220 of the dynamic multimedia server.

The static image server 214 includes a static image database 228, which contains static images uploaded onto the multimedia synchronization system 106 by users. In an embodiment, the synchronization application module 224 may convert uploaded static images into particular file formats and store these files in the dynamic multimedia database. As an example, slide presentation files may be converted into common image files. The uploaded static images in the static image database includes static images that are synchronized with one or more of the dynamic multimedia contents stored in the dynamic multimedia database 226, as well as static images that are not currently synchronized with any dynamic multimedia content. As illustrated in FIG. 2, the static image database may be stored in the storage device 220 of the static image server.

The synchronization record server 216 includes a synchronization record database 230, which contains records or information related to the synchronized presentations that have been created by users. The records contained in the synchronization record database include all the information needed to play the synchronized presentations. In an embodiment, the records for one synchronized presentation includes the name of the synchronized presentation, the file name or identifier of a dynamic multimedia content, the file name(s) or identifier(s) of static image(s), the time value within the play duration of the dynamic multimedia content for each static image. The time value for each static image is the point in time during the play duration of the dynamic multimedia content when that static image is to be displayed. As illustrated in FIG. 2, the synchronization record database may be stored in the storage device 220 of the synchronization record server.

Although each of the dynamic multimedia database 226, the static image database 228 and the synchronization record database 230 is shown in FIG. 2 as being stored in separate storage devices of different servers, each of these databases may be stored in multiple storage devices of one or more servers in some embodiments. In other embodiments, some or all of the dynamic multimedia database, the static image database and the synchronization record database may be stored in a single storage device or in multiple storage devices of a single server.

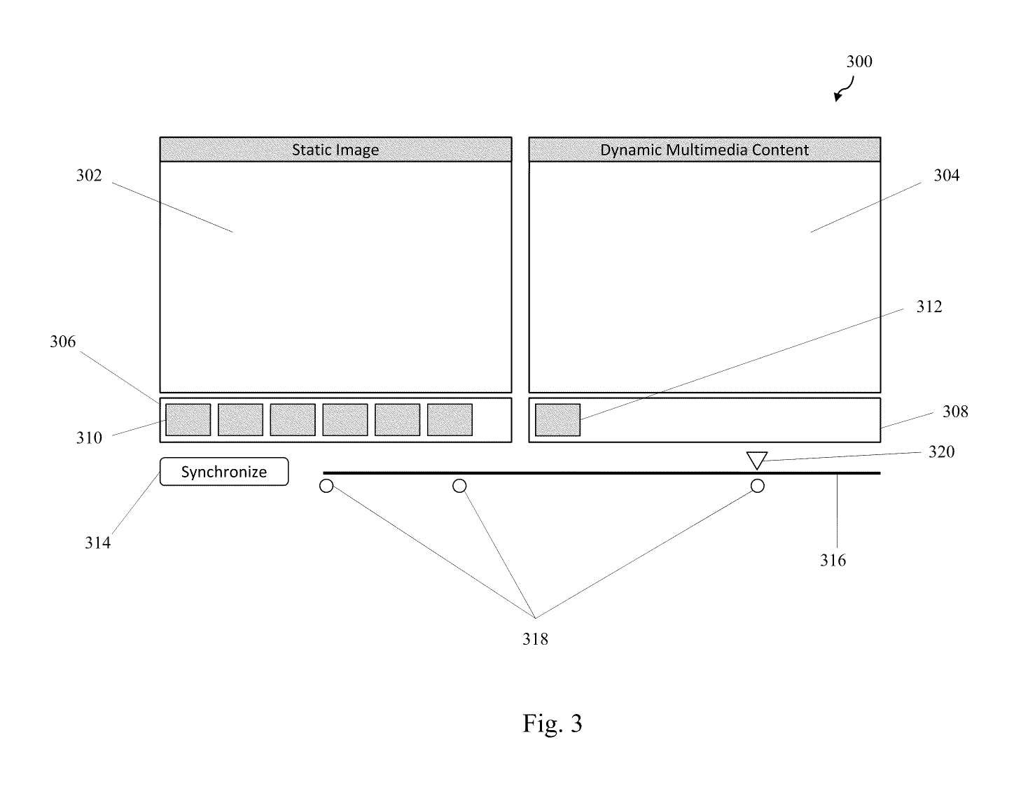

Turning now to FIG. 3, a synchronization user interface 300 for creating a synchronized presentation in accordance with an embodiment of the invention is shown. In an embodiment, the synchronization user interface is provided as a webpage by the webpage provider 222 to the computing devices 102 accessing the webpage. As shown in FIG. 3, the synchronization user interface includes a static image presentation area 302 and a dynamic multimedia presentation area 304. In the embodiment illustrated in FIG. 3, the static image presentation area and the dynamic multimedia presentation area are situated side by side. However, in other embodiments, the static image presentation area and the dynamic multimedia presentation area may be arranged in different configurations. For example, in some embodiments, the static image presentation area may be situated below or above the dynamic multimedia presentation area. The static image presentation area is used to individually display static images that have been selected. The dynamic multimedia presentation area is used to play a selected dynamic multimedia content of the synchronized presentation. Thus, any visual content of the dynamic multimedia content being played will be displayed in the dynamic multimedia presentation area.

As also shown in FIG. 3, the synchronization user interface 300 includes a static image thumbnail area 306 and an optional dynamic multimedia thumbnail area 308. In the illustrated embodiment, the static image thumbnail area is situated below the static image presentation area, and the dynamic multimedia thumbnail area is situated below the dynamic multimedia presentation area. However, in other embodiments, the static image thumbnail area and the dynamic multimedia thumbnail area may be situated in other locations in the synchronization user interface. The static image thumbnail area is used to display thumbnails 310 of static images, i.e., small versions of the static images, that can be selected to be synchronized with the dynamic multimedia content, and thus, be included in the synchronized presentation. In an embodiment, the static image thumbnail area is used to display full range of all static images that can be potentially selected by a user. The dynamic multimedia thumbnail area is used to display one or more thumbnails 312 of image frames of the dynamic multimedia content, which represent the entire dynamic multimedia content. The image frames displayed in the dynamic multimedia thumbnail area may be image frames of the dynamic multimedia content at certain time interval during the play duration. The dynamic multimedia presentation area is not used if the dynamic multimedia content includes just audio, i.e., the dynamic multimedia content is an audio file.

The synchronization user interface 300 further includes a synchronize button 314, a presentation timeline 316, one or more image markers 318 and a playback marker 320. The synchronize button is used to play the dynamic multimedia content for creating, replaying or editing the synchronized presentation. When the synchronize button is activated, the dynamic multimedia content is played in the dynamic multimedia presentation area 304, during which the still images can be synchronized to the dynamic multimedia content. In an embodiment, if no dynamic multimedia content is selected by a user, a default dynamic multimedia content is automatically selected by the synchronization application module and played. The default dynamic multimedia content may be an audio file with a fixed play duration. The presentation timeline represents the play duration for the dynamic multimedia content. The playback marker and the image markers represent specific moments on the presentation time line, and thus, represent specific points of time in the play duration of the dynamic multimedia content. The playback marker represents the current play time for the dynamic multimedia content. The image markers represent the points of time in the play duration of the dynamic multimedia content when the static images have been selected by the user, and thus, are to be displayed in the static image presentation area 302.

The process of creating a synchronized presentation in accordance with an embodiment is now described. A user using one of the computing devices 102 accesses a website supported by the multimedia synchronization system 106 via the network 104. The user then typically uploads one or more dynamic multimedia contents, such as video with audio files, and one or more static images, such as presentation slide files, from the computing device to the multimedia synchronization system. In an embodiment, the synchronization application module 224 of the application server 210 processes the uploaded data and stores them in the appropriate databases. The uploaded dynamic multimedia contents are stored in the dynamic multimedia database 226, while the uploaded static images are stored in the static image database 228.

The user then accesses the synchronization user interface 300 as a webpage via the website supported by the multimedia synchronization system 106 to create a synchronized presentation. The user selects one or more of the uploaded dynamic multimedia contents for the synchronized presentation being created. In this example, a single dynamic multimedia content is selected for the synchronized presentation, which causes the dynamic multimedia thumbnail area 308 to be populated with one or more thumbnails of image frames of the selected dynamic multimedia content. The user also selects one or more of the uploaded static images for the synchronized presentation being created. As a result, the static image thumbnail area 306 is populated with thumbnails of selected static images.

In an alternative implementation, rather than the user selecting one or more of the uploaded dynamic multimedia contents and one or more of the uploaded static images for the synchronized presentation, any uploaded dynamic multimedia content and any uploaded static image are automatically made available in the synchronization user interface 300 by the synchronization application module 224. Thus, each uploaded dynamic multimedia content will be available to be played in the synchronization user interface, as represented by one or more thumbnails of image frames of that uploaded dynamic multimedia content populated in the dynamic multimedia thumbnail area 308. In this example, only one dynamic multimedia content has been uploaded, and thus, only one dynamic multimedia content is available to be used for the synchronized presentation. In addition, each uploaded static image will be available to be synchronized with the uploaded dynamic multimedia content, as represented by the thumbnails of the uploaded static images populated in the static image thumbnail area 306.

The user then clicks or activates the synchronize button 314, which causes the dynamic multimedia content represented by the thumbnails of image frames in the dynamic multimedia thumbnail area 308 to play in the dynamic multimedia presentation area 304. As the dynamic multimedia content is played in the dynamic multimedia presentation area, the playback marker 320 moves along the presentation timeline 316, indicating the current play time of the dynamic multimedia content. At a desired point in time during the playback of the dynamic multimedia content, the user selects one of the thumbnails of static images displayed in the static image thumbnail area 306 using a single user input. In an embodiment, the user selects the desired static image thumbnail by making a single left mouse click or equivalent user input on the static image thumbnail. The selection of the static image thumbnail causes the corresponding static image to be displayed in the static image presentation area 302 and a new image marker to appear on the presentation timeline at the current position of the playback marker. The display of the static image in the static image presentation area will continue until another static image is selected. In addition, the information regarding the selected static image and the time when the static image was selected is stored in the synchronization record database 230 by the synchronization application module 224. The stored information is used to coordinate synchronized playback of the dynamic multimedia content with the selected static images when the synchronized presentation is played back. In an embodiment, the actual stored data files of the dynamic multimedia content and the selected images are not altered in any way as the synchronized presentation is created.

After the first static image is selected, the user can then select one or more additional static images to be synchronized with the dynamic multimedia content in the same manner. For each static image selected, the corresponding static image is displayed in the static image presentation area 302 and a new image marker is made to appear on the presentation timeline 316 at the position of the playback marker when that static image is selected. In addition, the information regarding each of the additional static images selected and the time when each additional static image was selected is stored in the synchronization record database 230.

In an embodiment, a static image may also be selected by dragging a thumbnail of a static image from the static image thumbnail area 306 and dropping the thumbnail on a particular position of the presentation timeline 316, which will produce a new image marker at that position of the presentation timeline. In some embodiments, the image markers on the presentation timeline may be moved to change when the corresponding static images will be displayed when the synchronized presentation is played.

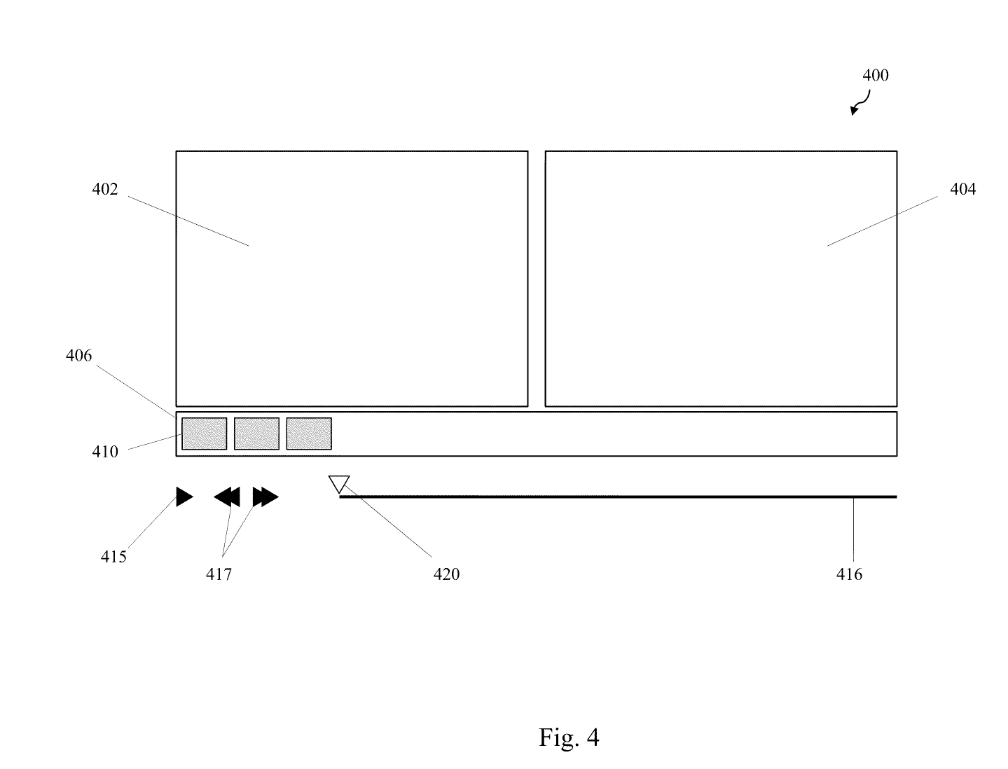

Turning now to FIG. 4, a playback user interface 400 for playing a synchronized presentation in accordance with an embodiment of the invention is shown. In an embodiment, similar to the synchronization user interface 300, the playback user interface is provided as a webpage by the webpage provider 222 to the computing devices 102 accessing the webpage. As shown in FIG. 4, the playback user interface includes a static image presentation area 402 and a dynamic multimedia presentation area 404. In the embodiment illustrated in FIG. 4, the static image presentation area and the dynamic multimedia presentation area are situated side by side. However, in other embodiments, the static image presentation area and the dynamic multimedia presentation area may be arranged in different configurations. The dynamic multimedia presentation area is used to play the dynamic multimedia content of the synchronized presentation. The static image presentation area is used to individually display the static images of the synchronized presentation as the dynamic multimedia content is played.

The playback user interface 400 further includes a static image thumbnail area 406. In the illustrated embodiment, the static image thumbnail area is situated below both the static image presentation area 402 and the dynamic multimedia presentation area 404. However, in other embodiments, the static image thumbnail area may be situated in another location in the playback user interface 400. The static image thumbnail area is used to display thumbnails 410 of the static images of the synchronized presentation.

The playback user interface 400 further includes a play button 415, a presentation timeline 416, skip slide buttons 417 and a playback marker 420. The play button is used to playback the synchronized presentation. When the play button is activated, the dynamic multimedia content of the synchronized presentation is played in the dynamic multimedia presentation area 404. Since the data file of the dynamic multimedia content was not altered when the synchronized presentation was created, the same data file of the dynamic multimedia content used to create the synchronized presentation is used to playback the dynamic multimedia content. As the dynamic multimedia is played, the playback marker moves along the presentation timeline, which represents the current play time for the dynamic multimedia content. During the course of playback of the dynamic multimedia content, the static images selected by the user at specific times during the synchronization process are automatically displayed in the static image presentation area one at a time. Since the data files of the selected static images were not altered when the synchronized presentation was created, the same data files of the static images used to create the synchronized presentation are used to display the static images in the static image presentation area. The playback of the dynamic multimedia content and the displays of the selected static images for the synchronized presentation are enabled by the records stored in the synchronization record database 230, which are used to retrieve the dynamic multimedia content of the synchronized presentation from the dynamic multimedia database 226 for playback and to retrieve the selected static images of the synchronized presentation from the static image database 228 for selective display. The stored records with respect to time values when the static images were selected during the synchronization process are used to display the static image database in the static image presentation area at the desired times during the play duration of the dynamic multimedia content.

In an embodiment, the playback user interface 400 is configured such that the user can drag the playback marker to any position on the presentation timeline (i.e., any moment of time in the playback duration of the dynamic multimedia content), which will cause an image frame of the dynamic multimedia content associated with that playback time on the presentation timeline to be displayed in the dynamic multimedia presentation area 404 and cause the specific static image associated with that playback time of the presentation to be automatically displayed in the static image presentation area 402.

In an embodiment, the playback user interface 400 may be configured such that the user can click any individual static image thumbnail in the static image thumbnail area 406, which will cause the corresponding static image to be displayed in the static image presentation area 402 and cause the dynamic multimedia content displayed in the dynamic multimedia presentation area 404 to jump to the playback time originally associated with that static image during the synchronization process, i.e., the playback time when the static image was selected during the synchronization process. In addition, the user can click the skip image buttons 417 to cause the previous or next static image to appear in the static image presentation area and cause the dynamic multimedia content displayed in the dynamic multimedia presentation area to jump to the playback time originally associated with that static image during the synchronization process.

In a particular implementation, Flex technology may be used to build the application to provide the synchronization user interface 300 of FIG. 3 and the playback user interface 400 of FIG. 4. In addition, Real Time Messaging Protocol (RTMP) and Hypertext Transfer Protocol (HTTP) may be used to transmit dynamic multimedia content and static image data between the multimedia synchronization system 106 and the computing devices 102 via the network 104 for both the synchronization process and the playback process. Furthermore, Java technology may be used in the web browsers of the user computing devices to save and load data related to the dynamic multimedia contents and the static images.

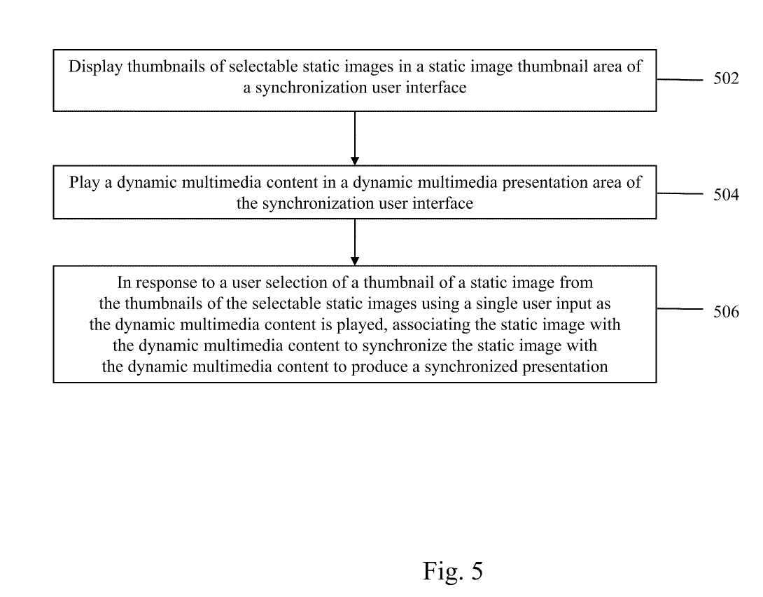

A method for synchronizing static images with dynamic multimedia contents to produce synchronized presentations in accordance with an embodiment of the invention is described with reference to a process flow diagram of FIG. 5. At block 502, thumbnails of selectable static images are displayed in a static image thumbnail area of a synchronization user interface. At block 504, a dynamic multimedia content is played in a dynamic multimedia presentation area of the synchronization user interface. At block 506, in response to a user selection of a thumbnail of a static image from the thumbnails of the selectable static images using a single user input as the dynamic multimedia content is played, the static image is associated with the dynamic multimedia content to synchronize the static image with the dynamic multimedia content to produce a synchronized presentation so that the static image is displayed as the dynamic multimedia content is played when the synchronized presentation is played.

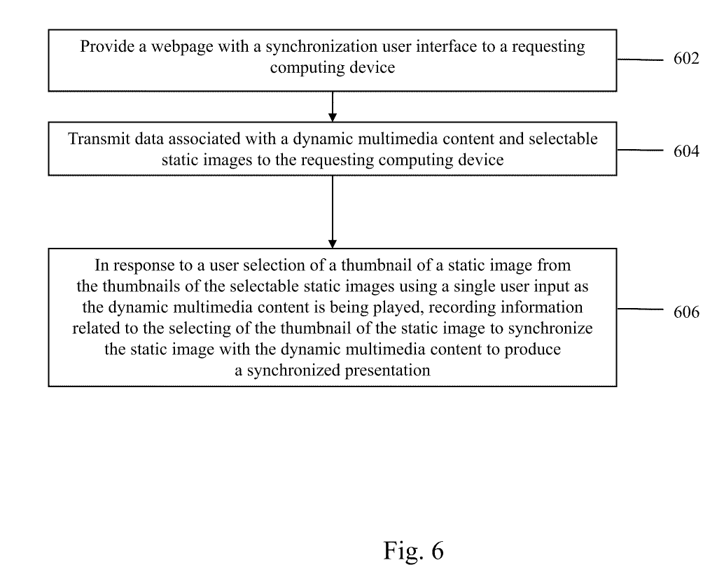

A method for synchronizing static images with dynamic multimedia contents to produce synchronized presentations in accordance with another embodiment of the invention is described with reference to a process flow diagram of FIG. 6. At block 602, a webpage with a synchronization user interface is provided to a requesting computing device. The synchronization user interface includes a static image thumbnail area to display thumbnails of selectable static images and a dynamic multimedia presentation area to play a dynamic multimedia content. At block 604, data associated with the dynamic multimedia content and the selectable static images is transmitted to the requesting computing device so that the dynamic multimedia content is played in the dynamic multimedia presentation area of the synchronization user interface and the thumbnails of the selectable static images are displayed in the static image thumbnail area of the synchronization user interface. At block 606, in response to a user selection of a thumbnail of a static image from the thumbnails of the selectable static images using a single user input as the dynamic multimedia content is being played, information related to the selecting of the thumbnail of the static image is recorded to synchronize the static image with the dynamic multimedia content to produce a synchronized presentation so that the static image is displayed as the dynamic multimedia content is played when the synchronized presentation is played.

Although the operations of the methods herein are shown and described in a particular order, the order of the operations of the methods may be altered so that certain operations may be performed in an inverse order or so that certain operations may be performed, at least in part, concurrently with other operations. In another embodiment, instructions or sub-operations of distinct operations may be implemented in an intermittent and/or alternating manner.

In addition, although specific embodiments of the invention that have been described or depicted include several components described or depicted herein, other embodiments of the invention may include fewer or more components to implement less or more feature.

Furthermore, although specific embodiments of the invention have been described and depicted, the invention is not to be limited to the specific forms or arrangements of parts so described and depicted. The scope of the invention is to be defined by the claims appended hereto and their equivalents.

What is claimed is:

1. A method for synchronizing static images with dynamic multimedia contents to produce synchronized presentations, the method comprising:
displaying thumbnails of selectable static images in a static image thumbnail area of a synchronization user interface;
playing a dynamic multimedia content in a dynamic multimedia presentation area of the synchronization user interface; and
in response to a user selection of a thumbnail of a static image from the thumbnails of the selectable static images using a single user input as the dynamic multimedia content is played, associating the static image with the dynamic multimedia content to synchronize the static image with the dynamic multimedia content to produce a synchronized presentation so that the static image is displayed as the dynamic multimedia content is played when the synchronized presentation is played.

2. The method of claim 1 wherein the dynamic multimedia content is a video file and wherein the playing of the dynamic multimedia content includes playing the video file.

3. The method of claim 2 further comprising displaying thumbnails of image frames of the dynamic multimedia content in a dynamic multimedia thumbnail area of the synchronization user interface as the dynamic multimedia content is played in the synchronization user interface.

4. The method of claim 1 wherein the dynamic multimedia content is an audio file, which is selected automatically when no dynamic multimedia content is selected by a user, and wherein the playing of the dynamic multimedia content includes playing the audio file.

5. The method of claim 1 wherein the single user input is a single left mouse click on the thumbnail of the static image displayed in the synchronization user interface.

6. The method of claim 1 wherein associating the static image includes recording an identifier of the static image and a time value of a play duration of the dynamic multimedia content at which the thumbnail of the static image is selected.

7. The method of claim 6 wherein the recording the identifier and the time value is executed without altering the original data files of the dynamic multimedia content and the static image.

8. The method of claim 1 further comprising displaying the static image in a static image presentation area of the synchronization user interface in response to the selecting of the thumbnail of the static image.

9. A method for synchronizing static images with dynamic multimedia contents to produce synchronized presentations, the method comprising:
providing a webpage with a synchronization user interface to a requesting computing device, the synchronization user interface including a static image thumbnail area to display thumbnails of selectable static images and a dynamic multimedia presentation area to play a dynamic multimedia content;
transmitting data associated with the dynamic multimedia content and the selectable static images to the requesting computing device so that the dynamic multimedia content is played in the dynamic multimedia presentation area of the synchronization user interface and the thumbnails of the selectable static images are displayed in the static image thumbnail area of the synchronization user interface; and
in response to a user selection of a thumbnail of a static image from the thumbnails of the selectable static images using a single user input as the dynamic multimedia content is being played, recording information related to the selecting of the thumbnail of the static image to synchronize the static image with the dynamic multimedia content to produce a synchronized presentation so that the static image is displayed as the dynamic multimedia content is played when the synchronized presentation is played.

10. The method of claim 9 wherein the dynamic multimedia content is a video file and wherein the transmitting of the dynamic multimedia content is transmitting the video file to the requesting computing device to be played in the dynamic multimedia presentation area of the synchronization user interface.

11. The method of claim 10 wherein the synchronization user interface further comprise a dynamic multimedia thumbnail area to display thumbnails of image frames of the dynamic multimedia content.

12. The method of claim 9 wherein the dynamic multimedia content is an audio file, which is selected automatically when no dynamic multimedia content is selected by a user, and wherein the transmitting of the dynamic multimedia content is transmitting the audio file to the requesting computing device to be played in the synchronization user interface.

13. The method of claim 9 wherein the single user input is a single left mouse click on the thumbnail of the static image displayed in the synchronization user interface.

14. The method of claim 9 wherein the recording the information related to the selecting of the thumbnail of the static image includes:
recording the file name of the static image and a time value of a play duration of the dynamic multimedia content at which the thumbnail of the static image is selected; and
storing the file name and the time value in a synchronization record database.

15. The method of claim 14 wherein the recording the information related to the selecting of the thumbnail of the static image is executed without altering the original data files of the dynamic multimedia content and the static image.

16. The method of claim 9 wherein the synchronization user interface further comprises a static image presentation area to display the static image in response to the selecting of the thumbnail of the static image.

17. A system for synchronizing dynamic multimedia contents with static images to produce synchronized presentations, the system comprising:
a synchronization record database residing in one or more servers, the synchronization record database being configured to store data related to the synchronized presentations;
a webpage provider executed in the one or more servers, the webpage provider being configured to provide a webpage with a synchronization user interface to a requesting computing device, the synchronization user interface including:
a static image thumbnail area to display thumbnails of selectable static images; and
a dynamic multimedia presentation area to play a dynamic multimedia content;
a synchronization application module executed in the one or more servers, the synchronization application module being configured to record information related to a selection of a thumbnail of a static image from the thumbnails of the selectable static images in the synchronization record database to synchronize the static image with the dynamic multimedia content to produce a synchronized presentation so that the static image is displayed as the dynamic multimedia content is played when the synchronized presentation is played.

18. The system of claim 17 wherein the dynamic multimedia content is a video file and wherein the synchronization user interface is configured to play the video file in the dynamic multimedia presentation area.

19. The system of claim 18 wherein the synchronization user interface further comprise a dynamic multimedia thumbnail area to display thumbnails of image frames of the dynamic multimedia content.

20. The system of claim 18 wherein the dynamic multimedia content is an audio file, which is selected automatically when no dynamic multimedia content is selected by a user, and wherein the synchronization user interface is configured to play the audio file.

21. The system of claim 18 wherein the single user input is a single left mouse click on the thumbnail of the static image displayed in the synchronization user interface.

22. The system of claim 18 wherein the synchronization application module is configured to:
record the file name of the static image and a time value of a play duration of the dynamic multimedia content at which the thumbnail of the static image is selected; and
store the file name and the time value in the synchronization record database.

23. The system of claim 22 wherein the synchronization application module is configured to record the information related to the selecting of the thumbnail of the static image without altering the original data files of the dynamic multimedia content and the static image.

24. The system of claim 18 wherein the synchronization user interface further comprises a static image presentation area to display the static image in response to the selecting of the thumbnail of the static image.
